(19) United States
(12) Patent Application Publication
(10) Pub. No.: US 2019/0341584 A1
(43) Pub. Date: Nov. 7, 2019

(54) ENERGY STORAGE DEVICES AND SYSTEMS

(71) Applicant: 3DBATTERIES LTD., Rehovot (IL)

(72) Inventors: Erez SCHREIBER, Rishon-LeZion (IL); Doron BURSHTAIN, Herzliya (IL); Reshef GAL-OZ, Kfar-Saba (IL); Anica LANCUSKI, Haifa (IL)

(73) Assignee: 3DBATTERIES LTD., Rehovot (IL)

(21) Appl. No.: 16/475,556

(22) PCT Filed: Jan. 2, 2018
(86) PCT No.: PCT/IB2018/050027

§ 371 Date: Jul. 2, 2019

Related U.S. Application Data
(60) Provisional application No. 62/441,462, filed on Jan. 2, 2017.
(60) Provisional application No. 62/441,463, filed on Jan. 2, 2017.

(51) Int. Cl. H01M 2/02; H01M 4/04; C25D 13/02; H01M 10/0525; H01M 4/38; H01M 4/48; H01G 11/78

(52) U.S. Cl. CPC H01M 2/028; H01M 4/0457; C25D 13/02; H01G 11/78; H01M 4/386; H01M 4/483; H01M 2/0207; H01M 10/0525

(57) ABSTRACT

Provided is a packaging element including a polymer layer and having a thickness of between 10 and 200 micro meter; wherein the packaging element being for use in providing an essentially sealed, void-free enclosure of an energy storage device, and wherein the polymer is selected from: poly(para-xylylene), poly-m-xylylene adipamide, dielectric polymer, silicone-based polymer, polyurethane, acrylic polymer, rigid gas impermeable polymer, fluorinated polymer, epoxy, polyisocyanate, PET, silicone rubber, silicone elastomer, polyamide and any combinations thereof.

### RELATED APPLICATIONS

This application claims the benefit of priority of U.S. Provisional Patent Application Nos. 62/441,462 and 62/441,463 filed Jan. 2, 2017, the contents of which are incorporated by reference as if fully set forth herein.

### FIELD AND BACKGROUND OF THE INVENTION

Some embodiments of the present invention relate to energy storage devices and systems, and, more specifically, but not exclusively, to components for energy storage devices and systems, including electrodes, electrolytes and packaging materials.

Energy storage systems can be utilized in a wide range of electronic applications, including computers, mobile devices, personal digital assistants, power tools, navigational and communications equipment, power storage and automotive management systems. The architecture of such systems is generally constructed of a cell composed of layers comprising an anode layer, a cathode layer and a membrane (electrolyte, separator) layer disposed therebetween. For example, a cylinder type cell or more advanced systems may utilize a “Jelly roll” or “Swiss roll” configuration, in which the cell can be rolled up and/or folded inside a pouch or enclosure to provide a protective packaging of the energy storage device to eliminate exposure of the layers to external environment, including, air, oxygen, carbon monoxide, carbon dioxide, nitrogen, moisture and organic solvents. However, a large footprint is typically required to achieve large capacity.

Evolution in energy storage devices due to introduction of new product categories, for example, wearable electronics and Internet of Things (IoT), including, smart bandages, wearables, cosmetic products, smart watches, portable electronics, wireless sensors, medical disposables and microelectromechanical systems (MEMS), increasingly requires improving attributes such as thinness, flexibility, light weight and low charging thresholds. Standard design limitations of energy storage devices dictate large footprints for products requiring large capacity, for example, due to the packaging layer that substantially increases weight and volume of the energy storage device, and consequently, reduces its energy density.

Other challenges involved in energy storage devices relate to properties of the layers of the cell. For example, the anode layer, which typically expands and contracts during the operation of the device, may eventually lead to mechanical and/or chemical failure and reduce the lifetime and/or degrade performance of the energy storage device.

### SUMMARY OF THE INVENTION

According to an aspect of some embodiments of the present invention, there is provided a packaging element comprising a polymer layer and having a thickness of between 10 and 200 μm; wherein the packaging element being for use in providing an essentially sealed, void-free enclosure of an energy storage device, and wherein the polymer is selected from: poly(para-xylylene), poly-m-xylylene adipamide, dielectric polymer, silicone-based polymer, polyurethane, acrylic polymer, rigid gas impermeable polymer, fluorinated polymer, epoxy, polyisocyanate, PET, silicone rubber, silicone elastomer, polyamide and any combinations thereof.

According to an aspect of some embodiments of the present invention, there is provided an energy storage module comprising an assembly comprising a two electrode layers and a separator layer disposed therebetween, said energy storage module being enclosed by a packaging element comprising a thin-film polymer layer and having a thickness of between 10 and 200 μm, the packaging element being configured to provide an essentially sealed, void-free enclosure of said energy storage module; wherein the polymer is selected from: poly(para-xylylene), poly-m-xylylene adipamide, dielectric polymer, silicone-based polymer, polyurethane, acrylic polymer, rigid gas impermeable polymer, fluorinated polymer, epoxy, polyisocyanate, PET, silicone rubber, silicone elastomer, polyamide and any combinations thereof.

According to an aspect of some embodiments of the present invention, there is provided an energy storage module comprising: (i) a substrate provided with a plurality of inner surface perforations or with a porous structure having an aspect-ratio above 2; (ii) an anode; (iii) a cathode; (iv) an electrolyte layer disposed between the anode layer and the cathode layer; wherein said layers being formed on a surface region of said substrate and throughout the inner surface of said perforations, or throughout said porous structure; wherein said energy storage module being enclosed by a thin-film packaging element having a thickness of between 10 and 200 μm and comprising a polymer, and being configured to provide an essentially sealed, void-free enclosure of said energy storage module; wherein the polymer is selected from: poly(para-xylylene), poly-m-xylylene adipamide, dielectric polymer, silicone-based polymer, polyurethane, acrylic polymer, rigid gas impermeable polymer, fluorinated polymer, epoxy, polyisocyanate, PET, silicone rubber, silicone elastomer, polyamide and any combinations thereof.

According to an aspect of some embodiments of the present invention, there is provided a method for electrophoretically depositing an electrode film on a substrate, the method comprising: (i) providing a dispersion comprising a solvent, said dispersion comprising a charger agent and charged particles dispersed therein; (ii) applying an electrical current sufficient to deposit a film comprising the particles on a surface region of the substrate; said particles comprise one or more of a functionalized porous carbon, graphite, graphene, carbon nanoparticles, carbon nanotubes, carbon fibers, and carbon rods, nanowires, fullerenes, silicon particles, and lithium titanate (LTO) particles; and said ratio between the charged particles and the charger agent is between 1:10 to 10:1% w/w.

According to an aspect of some embodiments of the present invention, there is provided electrode comprising a substrate and a film, the film comprising particles of a material deposited on a surface region of the substrate; said particles comprise one or more of a functionalized porous carbon, graphite, graphene, carbon nanoparticles, carbon nanotubes, carbon fibers, and carbon rods, nanowires, fullerenes, silicon particles, lithium titanate (LTO) particles; said electrode being for use in an energy storage device and having 200-2000 mAh/g capacity when cycled vs. lithium ion cathode or lithium metal.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings and images. With specific reference now to the drawings in detail, it is stressed that the particulars shown are by way of example and for purposes of illustrative discussion of embodiments of the invention.

In this regard, the description taken with the drawings makes apparent to those skilled in the art how embodiments of the invention may be practiced.

In the drawings:

FIG. 1 is a thin-film battery comprising the packaging element according to Example 1 of the present invention;

FIG. 2 is a thin-film battery comprising the packaging element according to Example 2 of the present invention;

FIG. 3 is a cross sectional illustration of the packaging element according to some embodiments of the present invention;

FIG. 4 is cross sectional illustration of the packaging element showing initial backbone substrate according to some embodiments of the present invention;

FIG. 5 is an illustration of the packaging element showing 3D layered structure with counter electrode inside the pores according to some embodiments of the present invention;

FIG. 6 is an illustration of the packaging element showing “3D” layered structure with counter electrode outside the pores according to some embodiments of the present invention;

FIG. 7 is a flowchart of an exemplary method according to some embodiments of the present invention;

FIG. 8 is a SEM image of a graphite anode according to Example 1 according to some embodiments of the present invention;

FIG. 9 is a SEM image of a silicon anode according to Example 2 according to some embodiments of the present invention relating to electrophoretic deposition; and

FIGS. 10A-10B show SEM images of a ceramic composite separator deposited according to Example 6 of the present invention relating to electrophoretic deposition.

### DETAILED DESCRIPTION

Some embodiments of the present invention relate to energy storage devices and systems, and, more specifically, but not exclusively, to components for energy storage devices and systems, to components for energy storage devices and systems, including electrodes, electrolytes and packaging materials.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments and/or of being practiced and/or carried out in various ways.

Some embodiments of some aspects of the invention aim at providing an energy storage device and/or system having a combination of improved attributes, such as energy capacity, energy density, thickness (e.g., thin), weight, cost, safety, reliability, durability, and ease of manufacture. Some embodiments provide a rechargeable energy storage device, having further improved attributes, such as thermal loading, recharge rate and other performance properties. Other attributes, including, for example, design and/or engineering factors may be dictated based on energy storage application, e.g., large scale energy storage systems for transportation and/or industrial power systems, as compared to smaller scale energy storage systems (e.g., batteries) for consumer electronic devices, such as, computers, mobile devices, and/or the like.

Some embodiments of some aspects of the invention provide an improved energy storage device and/or system, with increased cycle life and/or performance over various operational configurations and/or applications. Some embodiments of the invention provide a thin-film energy storage device having improved attributes, such as, increased energy capacity and/or energy density. The thin-film energy storage device according to some embodiments of the invention is composed of a laminar cell structure, comprising a plurality of layers having: an anode layer, a cathode layer and a membrane layer disposed therebetween. The thin-film energy storage device may be encapsulated with a thin layer (e.g., outer surface/enclosure) for providing adequate protection from exposure of the device and/or its components to volatile materials existing in external environment, e.g., air, oxygen, carbon monoxide, carbon dioxide, nitrogen, moisture and organic solvents; and/or for structural support.

Laminated packaging of an energy storage device may substantially increase weight and volume of the energy storage device, and consequently, reduce the energy density of the device. For example, a laminated packaging layer can be typically hundreds of micrometers thick to provide adequate protection and/or structural support, whereas the energy storage components (e.g., anode, cathode, and separator) can be a few micrometers thick. The Inventors found that by utilizing a packaging element in encapsulating the energy storage device according to some embodiments of the invention, afforded a substantial increase in energy density and performance.

A protective layer/film of polymer can be laminated onto the device's structure to enclose the energy storage device and as such, serve as protective package element. To provide laminated structures having a desired thickness (e.g., decreased thickness as compared to the overall thickness of the original device), some embodiments of some aspects of the invention provide an energy storage device having a protective layer (e.g., packaging layer) adapted to effectively eliminate exposure of the device's layers to harmful materials in the external environment, and having a desired thickness and/or weight.

An objective of some embodiments of some aspects of the present invention is to provide a thin enclosure layer (also referred herein as the packaging element) that is capable of encapsulating completely and conformably an energy storage system, specifically a battery, to thereby result in essentially sealing of the system; on the one hand, by eliminating leakage of gases or other contaminants from the environment into the system, and on the other hand, by sealing said system to eliminate leaching out of materials (e.g., the electrolyte or reaction gases) from within the system through the polymer layer. Any type of form or design of an energy storage system can be essentially sealed by conformably depositing said enclosure layer thereon.

In addition, an objective of the present invention is to provide a durable and cost effective energy storage module that is designed to maximize energy density and efficiency, while minimizing volume restrictions, and that is capable of prolonged operation at various temperatures and conditions. This is feasible, according to some embodiments of the present invention, by providing an energy storage system that includes a packaging element which provides a barrier against penetration of contaminants, such as, air and water vapor. The packaging element comprises a thin barrier film of a protective flexible polymer coating enclosing the whole energy storage module, and thereby providing a protective sealing from outside environment for a prolonged time.

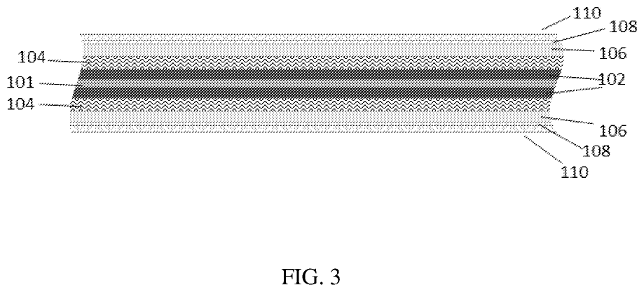

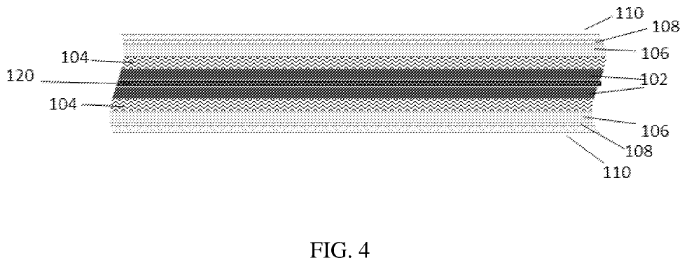

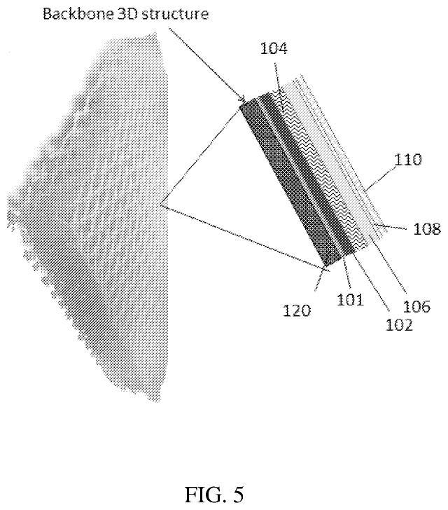

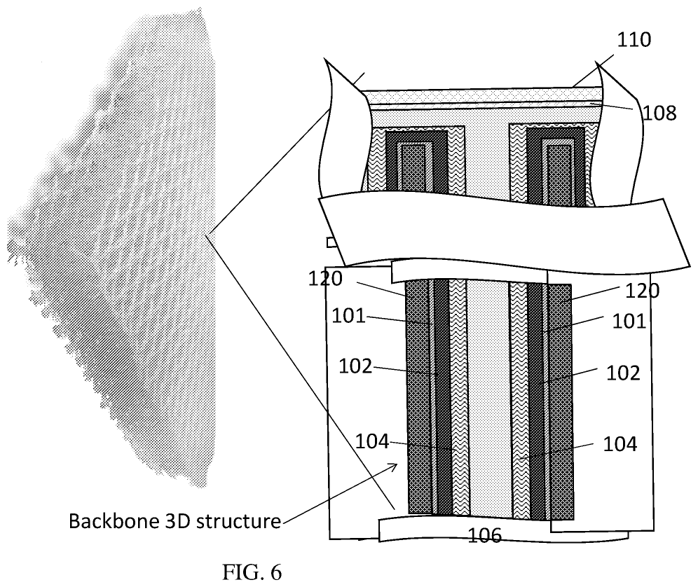

Reference is now made to the drawings. FIGS. 3-6 illustrate the packaging element according to several embodiments of the present invention. FIG. 3 is a cross sectional illustration of the packaging element according to some embodiments of the present invention on a thin film battery 100 of 2D (planar) layered structure according to an exemplary energy storage device of some embodiments of the invention. Reference numerals show the following components of the battery 100: 101 is a current collector, 102—is an anode or cathode, 104 is a separator, 106—cathode or anode, 108—conductive substance, 110—sealing layer(s). The battery 100 includes components which have been fabricated, or built up, onto a substrate. Each component may be provided by a film deposited on the substrate. FIG. 4 is cross sectional illustration of the packaging element showing initial backbone substrate 120 according to some embodiments of the present invention. Initial backbone 120 substrate, can be conductive and/or non-conductive. FIG. 5 is an illustration of the packaging element showing 3D layered structure with counter electrode inside the pores according to some embodiments of the present invention. FIG. 6 is an illustration of the packaging element showing 3D layered structure with counter electrode outside the pores according to some embodiments of the present invention.

A further objective of the present invention is to provide energy storage components protected for long periods of time and having adequate structural support. Thus, according to some embodiments of some aspects of the invention, there is provided a packaging element comprising a polymer; wherein the packaging element having a total thickness of 10 and 200 μm (e.g., a thin-film); said packaging element being for use in providing an essentially sealed, void-free enclosure of an energy storage device.

As used herein, essentially sealed refers to hermetically sealing of said energy storage device by providing a thin polymeric encapsulant extending continuously (e.g., void-free) around the faces of the energy storage device so that no contaminants (such as, air, water vapor, gases, electrolyte) can penetrate into or escape from the system.

Thus, the packaging element enables obtaining an energy storage system that is moisture-resistant, i.e., has a moisture permeability of less than about 10 g/(mil*100 inch²)/day, at times, less than 8 g/(mil*100 inch²)/day, at times, less than 5 g/(mil*100 inch²)/day, at times less than 3 g/(mil*100 inch²)/day. Further at times, less than 2 g/(mil*100 inch²)/day, yet further at times less than 1.5 g/(mil*100 inch²)/day.

The packaging element comprises a flexible polymer that is suitable to provide a sealing layer of the components assembly of the energy storage device joined together. Without being bound by the theory, the inventors realized that the packaging element also allows the electrodes to change volume during operation of the energy storage device (i.e., during charge and discharge), and thus, enables operation of the energy storage device during prolonged cycling. Some non-limiting examples of polymers suitable for the packaging element include epoxy resin, parylene (poly(p-xylylene)) and polyamide derivatives. In some embodiments, the polymer is selected from poly(para-xylylene) (grades N, C, D, HT, and any combinations thereof), poly-m-xylylene adipamide, dielectric polymer, silicone-based polymer, polyurethane, acrylic polymer, rigid gas impermeable polymer, a curable fluorinated polymer, a curable epoxy, a polyisocyanate, PET and any combinations thereof, silicone rubber, silicone elastomer, polyamide. In some embodiments, the poly(para-xylylene) is a chloro-substituted parylene, such as polymonochloro-p-xylylene and poly-dichloro-p-xylylene.

Some embodiments of some aspects of the invention provide a method of coating an energy storage device with a polymer, e.g., parylene. In some embodiments, the method comprises a process first step which starts with a dimer rather than a polymer and, in commercial equipment, polymerizes it on the surface of an object. To achieve this, the dimer first goes through a two-step heating process. The solid dimer is converted to a reactive vapor of the monomer and then, when passed over room temperature objects, the vapor will condense as a polymeric coating. Parylenes may be produced by vapor phase deposition in a variety of forms. By effecting polymerization in an aqueous system, parylene can be obtained in a particulate form.

It can also be deposited on a cold condenser, then stripped off as a free film, or it can be deposited onto the surface of an object as a continuous adhering coating in thicknesses ranging from 0.2 microns to 3 mm or more.

In some embodiments, the polymer, wherein the polyisocyanate is derived from at least one isocyanate selected from the group consisting of xylylene diisocyanate and bis(isocyanatomethyl)cyclohexane.

As above mentioned, some embodiments of the present disclosure provide an energy storage system having a high volumetric energy density. This is obtained, according to the present invention by, e.g., providing an ultra-thin and conformal packaging enclosure, which replaces the conventional relatively-thick packages known in the art. In some embodiments, the energy storage device comprises a packaging element having a thickness in the range of 10 μm to 200 μm, 20 μm to 200 μm, 30 μm to 200 μm, 40 μm to 200 μm, 50 μm to 200 μm, 60 μm to 200 μm, 70 μm to 200 μm, 80 μm to 200 μm, 90 μm to 200 μm, 100 μm to 200 μm; 10 μm to 80 μm, at times 10 μm to 70 μm, at times 15 μm to 60 μm, at times 20 μm to 50 μm, at times 20 μm to 40 μm, further at times 20 μm to 35 μm; 30 μm to 180 μm, 40 μm to 180 μm, 50 μm to 180 μm, 60 μm to 180 μm, 70 μm to 180 μm, 90 μm to 180 μm, 100 μm to 180 μm, 110 μm to 180 μm, 120 μm to 180 μm, 130 μm to 180 μm, 140 μm to 180 μm; 20 μm to 150 μm, 30 μm to 150 μm, 40 μm to 150 μm, 50 μm to 150 μm, 60 μm to 150 μm, 70 μm to 150 μm, 20 μm to 160 μm, 30 μm to 160 μm, 40 μm to 160 μm, 50 μm to 160 μm; 20 μm to 100 μm.

Typical electrochemical energy storage systems include an assembly that comprises two electrode layers and an ion-permeable layer, i.e., separator layer disposed therebetween, and/or an electrolyte ionically connecting both electrodes (also referred as: electrolyte). The reactants of the cell are subjected to redox reactions. One type of electrochemical energy storage system is a supercapacitor, in which when the electrodes are polarized by an applied voltage, ions in the electrolyte form electric double layers of opposite polarity to the electrode's polarity. As such, positively polarized electrodes have a layer of negative ions at the electrode/electrolyte interface along with a charge-balancing layer of positive ions adsorbing onto the negative layer. The opposite is true for the negatively polarized electrode.

Some example of energy storage systems that can be utilized by the present invention include any electrochemical energy storage cell, such as a battery, lithium battery, lithium-ion battery, all solid state lithium-ion battery, supercapacitor, hybrid capacitor, lithium-ion capacitor, ultra-capacitor, solid electrolyte supercapacitor, solid electrolyte hybrid lithium-ion supercapacitor, etc.

When the energy storage system is a battery, the assembly comprises the following components: an anode layer (negative electrode), a cathode layer (positive electrode) and a separator layer (also referred as: “electrolyte”) disposed therebetween the electrodes. Each of the anode and cathode typically include a current collector, such as aluminum and copper, for the cathode and anode, respectively. The reactants of the cell are subjected to redox reactions.

Methods of preparing an energy storage device according to some embodiments of the invention, include forming a base layer on a substrate, and forming an energy storage stack on the base. The energy storage stack includes at least one joining of separate components of the following layers: two electrode layers, and an electrolyte layer between the anode and cathode.

An energy storage system typically includes electrical connectors to the energy storage stack, which are configured for connecting the stack (or multilayer stack of cells) to an electronic device, for example in a battery, anode and cathode electrode connectors are coupled to the anode and cathode layers, respectively.

An additional method of preparing an energy storage system according to the present disclosure is by providing a base layer (for example, aluminum foil) and consecutively forming layers thereon. For instance, forming a cathode layer on the aluminum foil, followed by forming an electrolyte layer thereon, and further followed by forming an anode layer on the cathode layer (or by forming an anode layer on a current collector and joining said layer to the electrolyte layer). The forming can also be carried out in a reverse order, i.e., by initially forming the anode layer, then the electrolyte layer, and then the cathode layer. The forming can be carried out by any conventional method known in the art, for example, electrophoretic deposition or simple spreading (e.g., by doctor blade).

The energy storage system also includes a 3D electrode cell designated herein as a cell composed of one of the electrodes coated on electrically conducting substrate, a flat layer of separator or polymer electrolyte coated on the surface of the 3-dimensional electrode and a flat layer of the opposite polarity electrode or alternatively, electric conductive foil or film deposited from both sides.

The use of three-dimensional substrates in comparison to flat substrates results in an increase of the surface area of the substrate. The increase factor is known in the literature as Area Gain (AG). For example, the AG of perforated substrates of thickness of 0.1 mm to 5 mm result in an AG of 3-200.

In addition, the device can be a flat flexible battery in which three active layers: cathode, separator and anode, are deposited on both sides of electrically conducting thin-film conformably. The resulted electrochemical device can be used as one layer or in winded/rolled configuration. Such battery configuration can serve as a battery with standard thickness electrodes or with an ultra-thin flexible battery for wearable electronics, energy storage for IoT and surface mounted energy storage devices. The area gain of a foil substrate coated from both sides is referred herein to have an AG of 2.

A flat substrate is referred to herein as a substrate having an AG of 1. Some non-limiting examples of flat substrates include, metals such as nickel, aluminum, stainless steel, copper and gold); metal fabrics; polymers such as polyethylene terephthalate (PET), polydimethylsiloxane (PDMS), polyamide (Nylon), polyethylene (PE), polypropylene (PP), poly (methyl methacrylate) (PMMA), polystyrene (PS), polytetrafluorethylene (PTFE), polyvinylchloride (PVC), polyurethane (PU), polycarbonate (PC); carbon material such as carbon fiber mat, carbon nanotubes mat, carbon fabric and carbon paper.

The energy storage system according to some embodiments of the present invention includes a lithium-ion rechargeable battery. According to some embodiments of the present invention, the electrolyte comprises a solvent suitable for reducing a material to form an insoluble solid electrolyte interphase (SEI) on the anode surface. Such solvents include aprotic solvents such as ethylene carbonate (EC), diethylcarbonate (DEC), dimethylcarbonate (DMC), ethyl methyl carbonate (EMC), butyl carbonate, propylene carbonate, vinyl carbonate, dialkylsulfites and any mixtures thereof. In addition, metal salts known in the art to be suitable as good SEI precursors include: LiPF₆, LiBF₄, LiAsF₆, LiCF₃, and LiN(CF₃SO₂)₂, LiCF₃SO₃, LiI, LiBOB and LiBr.

In some embodiments, the lithium-ion battery comprises a liquid electrolyte. For example, the liquid electrolyte can comprise an aprotic solvent from the above-mentioned list and a lithium salt, such as LiPF6. In some embodiments, the liquid electrolyte comprises at least one lithium salt in an organic solvent. In such embodiments, the organic solvent comprises at least one of: ethylene carbonate, dimethyl carbonate, diethyl carbonate, ethyl methyl carbonate, butyl carbonate, propylene carbonate, vinyl carbonate, dialkylsulfites and fluoroethylene carbonate. In further embodiments, the liquid electrolyte comprises an ionic liquid.

Ionic liquids as used herein are salts with organic components and are liquids at temperatures below 100° C. They are highly stable, with almost no vapor pressure and are thus non-volatile. The presence of the cation tends to give ionic liquids high ionic conductivity, making them excellent replacements for conventional battery liquid electrolytes. Some non-limiting examples include, an ionic liquid comprising 1-ethyl-3-methyl imidazolium, 1-Butyl-3-methylpyridinium bis(trifluormethylsulfonyl), 1-Butyl-1-methylpyrrolidinium bis(fluorosulfonyl)imide, 1-Methyl-1-(2-methoxyethyl)pyrrolidinium bis(fluorosulfonyl)imide, 1-Ethyl-3-methylimidazolium tetrafluoroborate, N-ethyl-N-methylpiperidinium bis(fluorosulfonyl)imide.

In some other embodiments, the lithium-ion battery disclosed herein comprises a solid or gel polymer electrolyte. Namely, a polymer electrolyte contains a polymer, preferably polyethylene oxide, adapted to form a complex with the metal salt (for example, from the above-mentioned list), and optionally, a nano-size ceramic powder to form a composite polymer electrolyte.

In some embodiments, the energy density and specific energy of flexible batteries, which express the energy capacity of the battery per unit volume and weight, respectively, are important performance parameters, and consequently, it is desirable to increase the energy density and specific energy of such batteries. By utilizing the energy storage module of the present invention, having an ultra-thin packaging element, a high volumetric energy density and specific energy of such modules is obtained.

In some embodiments, the energy storage module, having a volumetric energy density of at least 200 mAh per liter (mAh/l) when said battery module is discharged at a current of 0.01 mA/cm2.

In some embodiments, the battery module, having a gravimetric energy density of at least 40 mAh per g (mAh/g) [measured via charging to nominal voltage and discharging to 50% of the nominal voltage or to 0.1V vs. lithium.

Also provided by the invention is an energy storage module, having at least one of the following properties having high tensile strength measured by Tensile Tester with a 0.2 kN load cell or equivalent, having high toughness measured by subjection to a total of 1,000 bending cycles, the cell remains testably functional and does not show any cracked part after testing the cell in accordance with the test methods described in ISO/IEC 10373-1 and international standard ISO/IEC 7810. Additionally or alternatively, when subjected to a total of 1,000 torsion cycles, the cell remains testably functional and does not show any cracked part after testing in accordance with the test methods described in ISO/IEC 10373-1. Additionally or alternatively, the bending cycles measured by measuring the cell capacity after nending 100-1000 time at 45°, 90° and 120° bending angle.

Additionally or alternatively, the energy storage module has a moisture permeability of less than about 10 g/(mil*100 inch2)/day.

Additionally or alternatively, the thin-film coating (packaging) element having no gaps between different components of the material when viewed at a magnification revealing structures above about 0.1 μm.

Additionally or alternatively, the thin-film packaging element has good adhesion of the parylene layer to adhesives such as paint.

Additionally or alternatively, the energy storage module has stable mechanical properties measured on electrochemical cells and/or half cells before cycling, during cycling every 10% of cycle life.

The energy storage module of the invention may also be characterized by its tensile modulus of elasticity (also referred to at times by the terms elastic modules or tensile modulus). The tensile modulus of elasticity is generally defined by a material's resistance to be deformed elastically (i.e. non-permanently) when a force is applied to it. The higher the force required, the stiffer the material. Typically, the energy storage module has a high tensile modulus of elasticity. Thus, the flexible polymeric enclosure provided herein can be formed as a structure having a desired shape.

The battery module of the invention may also be characterized by one or more of the following characteristics: Tensile strength, namely, the stress at which a material fails or permanently deforms under tension.

Flexural strength (also referred to at times by the term bend strength), namely, the stress applied to a material at its moment of rupture.

Flexural modulus refers to the material's stiffness in flexure, namely, its resistance to deformation by an applied force.

Charpy Impact (Charpy V-notch test) refers to the energy per unit area required to break a test specimen under flexural impact.

Surface Energy refers to the surface tension of a material. It is well understood that in order for two materials to adhere to each other their surface energies (surface tension), should be alike.

Also peel tests are a common tool for measuring the adhesion in energy storage devices. Any interface in a device that delaminates could potentially create paths to water intrusion and so determining the adhesion strength between layers is important. Several methods known in the art can be used to measure the adhesion force of thin films. The “scotch test tape” qualitative tests the adhesion of a film deposited on a substrate by applying a piece of pressure sensitive tape to the film and pulling the tape off. If the top layer of the deposited film comes off (either in parts or in pieces), it is said to have “failed” the test. The adhesion force of the film can also be determined using a load cell connected to the free end of a film which is then pulled at a 90° angle to a fixed substrate or 180° to a second attached flexible film, to measure force required to separate the film from a substrate. The peel strength is defined as the average load per unit width of bond-line required to progressively separate the two materials.

Electrochemical impedance spectroscopy (EIS) identifies signs of failure in the device (e.g., delamination, water or gas penetration) by measuring the impedance between traces (the lateral impedance) and the impedance between a trace and an external counter electrode (transverse impedance).

The present invention also provides an energy storage module comprising a packaging element that comprises a polymer, wherein the polymer provides a void-free and homogeneous enclosure extending continuously around the faces' sides and around the periphery of the energy storage module. Thus, in accordance with the present invention, the term “void-free” refers to polymer particles formed (e.g., deposited) on the surface are very closely associated with the surrounding medium such that gaps, if any, are of a size (width) of less than 0.1 μm, when observed, inter alia, by scanning electron microscopy, or by other suitable techniques known in the art for revealing such gaps. While not wishing to be bound by theory, this is believed to be a result of the adhesive properties (surface energy) of the polymeric packaging material that is comprised in said surrounding medium.

The battery module comprises the two following layers of components: a cathode layer, a separator (electrolyte) and an anode layer. The cathode layer comprises a cathode material including, but not limited to, lithium cobalt oxide, lithium iron phosphate, lithium manganese oxide, lithium nickel cobalt oxide, lithium nickel cobalt aluminum oxide, lithium nickel cobalt manganese oxide. In some embodiments, the cathode is further coated with a thin layer comprising a conductive material selected from LiNbO3, copper sulfide, 2D layered oxides, vanadium oxide. In some embodiments, the cathode layer comprises lithium cobalt oxide or lithium iron phosphate.

In some embodiments, the cathode comprises activated carbon from natural source such as coconut, tar, wood, tabaco leaves, plants, organic polymers.

The cathode further comprises a binder having a concentration of 0-15% w/w and conducting additives having a concentration of 0-15% w/w. Some non-limiting examples of conducting additives include carbon black, multi-wall carbon nanotubes (MWCNT), single-wall carbon nanotubes (SWCNT), graphene flakes, graphene oxide flakes, activated carbon and graphite.

Some non-limiting examples of binders include the polymers or co-polymers: cellulose based polymers, polyethylene oxide, Polyvinylidene fluoride (PVDF), Polyethylene oxide (PEO), Polyethylenimine (PEI), Polyvinyl chloride (PVC), Polytetrafluoroethylene (PTFE), composites of orthosilicate polymer derivatives, sodium/lithium carboxy methyl cellulose (NaCMC/LiCMC), cellulose based binder and poly-methyl methacrylate (PMMA).

The deposition of the cathode layer on the current collector or on the separator layer, can be carried out by any conventional method known in the art, including, but not limited to, by electrodeposition or spin coating, electrophoretic deposition process or aqueous electrophoretic deposition in AC electric fields (AC-EPD), chemical vapor deposition (CVD) or a process and electrochemically induces sol gel process.

The anode layer comprises an anode material including, but not limited to, graphite, graphite infused with lithium ions, silicon, silicon carbon composite, nano particles, silicon nanotubes or carbon-silicon composite agglomerates, tin and tin oxide particles, graphene, hard carbon, lithium, lithium titanium oxide (LTO). For symmetric supercapacitor or ultra-capacitor: activated carbon from natural source such as coconut, tar, wood, tabaco leaves, plants, organic polymers.

The anode further comprises a binder having a concentration of 0-15% w/w and conducting additives having a concentration of 0-15% w/w. Some non-limiting examples of conducting additives include carbon black, multi-wall carbon nanotubes (MWCNT), single-wall carbon nanotubes (SWCNT), graphene flakes, graphene oxide flakes, activated carbon and graphite.

Some non-limiting examples of binders include the polymers or co-polymers: cellulose based polymers, polyethylene oxide, Polyvinylidene fluoride (PVDF), Polyethylene oxide (PEO), Polyethylenimine (PEI), Polyvinyl chloride (PVC), Polytetrafluoroethylene (PTFE), sodium/lithium carboxy methyl cellulose (NaCMC/LiCMC), cellulose based binder and poly-methyl methacrylate (PMMA.

The deposition of the anode layer on the current collector or on the separator layer, can be carried out by any conventional method known in the art, including, but not limited to, by electrodeposition, spin coating, electrophoretic deposition process. In some embodiments, the anode comprises silicon particles.

It is a further object of the present invention to provide an energy storage system (for example, a three-dimensional microbattery) having at least one of a high power density, high capacity and high energy density.

The above objects are achieved by the present invention, by utilizing a substrate having throughout perforations in the substrate's structures (referred herein also as: “three-dimensional substrate” or “three-dimensional battery”). The use of such a substrate increases the available area for thin-film deposition, thus leading to an increase in volume, i.e., increase in the capacity of the cell.

The 3D battery technology described herein, is a design which turns the complete thin-film cell structure from a planar geometry into a 3D network placed on a small footprint and small volume, increasing power by reducing the length of the diffusion path.

Thus, in yet another of its aspects, the present disclosure provides an energy storage module comprising: a substrate provided with a plurality of inner surface perforations having an aspect-ratio above 2-200 a thin layer anode; a thin layer cathode; an electrolyte layer disposed or separator layer between the anode layer and the cathode layer; said layers being formed on a surface region of said substrate and throughout the inner surface of said perforations; said energy storage module is enclosed by a thin-film packaging element comprising a polymer; wherein the thin-film packaging element is configured to provide an essentially sealed, void-free enclosure of said energy storage module; and wherein the packaging element having a thickness of 10 μm to 200 μm.

In some embodiments, the energy storage module being an on-chip battery. In some embodiments, the energy storage device is a symmetrical or hybrid supercapacitor comprising two electrodes and separator impregnated with electrolyte. In the case of symmetrical supercapacitor the electrodes compirse activated carbon with surface area of 700-2500 square meter per gram 70-100% w/w of the electrode solid content, binder such as polyvinylidene fluoride (PVDF), polyethylene oxide (PEO), polytetrafluoroethylene (PTFE), or poly-methyl methacrylate (PMMA) 0-20% w/w of the electrode solid content and 0-10% w/w of the electrode solid content electrically conducting additive such as carbon nanotubes or carbon black.

The hybrid supercapacitor comprises lithium ion cathode as positive polarity and activated carbon as the negative polarity. The electrolyte in both symmetric and asymmetric supercapacitors can be aqueous or organic. Aqueous electrolyte is acidic, basic or neutral electrolyte, such as sulfuric acid, potassium hydroxide and sodium sulfate. Organic electrolyte for supercapacitor may be acetonitrile with ammonium salt based electrolyte for symmetric supercapacitor or carbonate based electrolyte with lithium salt for hybrid supercapacitor.

In some embodiments, the energy storage device, battery or supercapacitor, is in the form of at least two stacked cells connected in parallel or series. In a stacked configuration, the cells arranged on top of each sequential cell or next to each other. The above electrochemical device is connected, in the series configuration, to the electric circuit from one polarity of the first cell to the opposite polarity of the last cell in stack and in the parallel configuration each cell in the stack is connected to the circuit by both positive and negative port. In both parallel and series configurations the cells are balanced passively by weight balance of the cell electrodes or by active BMS device.

Standard energy storage devices utilize various forms of carbon as an electrode (e.g., in lithium batteries a carbon film is used as an anode) and a commercial separator, such as Celgard. Anode materials, such as graphite, may be used in energy storage devices (e.g., batteries), such as rechargeable Li-ion batteries. Although graphite has low cost, good cycling performance as well as low electrochemical potential, its relatively low specific storage capacity limits current batteries from various potential applications. Finding new electrode material with higher capacity or higher energy density has been one of the most important research focuses. Silicon is an attractive alloy-type anode material because of its high capacity (4,200 mAh/g) and maximum Li uptake. This is a significant improvement over the 372 mAh/g provided by graphite. Unfortunately, lithium insertion into and extraction from silicon are accompanied by a huge volume change (up to 300%), which induces a strong stress on the silicon particles and causes pulverization and rapid capacity fading (e.g., loss in capacity over cycles).

In recent years, silicon has been found to offer 10 times more energy density as compared to carbon anode. However, silicon suffers two major drawbacks: (1) low electronic conductivity, (2) three times volume expansion during charging (3) low diffusivity of Li and mechanical failure (cracks). To utilize the high energy density of silicon while minimize its drawbacks, various forms silicon-carbon composites have been developed and demonstrated to with limited performance. Most of these composites were manufactured with high-cost and multi-step chemical vapor deposition (CVD) methods. These methods require sophisticated and expensive equipment making them either undesirable or impracticable for implementation in manufacturing environment. They also involve high processing temperatures and employment of toxic precursors.

Some embodiments of the invention provide an electrophoretic deposition reel-to-reel continuous operation system and a method for preparing a silicon-based anode material for lithium-ion battery.

Some embodiments of the invention provide a preparation method of a silicon-carbon anode material for lithium-ion battery, which comprises the steps of: (1) forming a silicon-carbon composite material by electrophoretic deposition method; (2) peeling off the silicon-carbon composite material from the electrode to carry out drying treatment; and (3) then carrying out carbonization treatment on the dried silicon-carbon composite material in an inert atmosphere to obtain the silicon-carbon anode material for lithium-ion battery.

Some embodiments of the invention provide a novel method for producing a composite films on both planar (2D) and three-dimensional (3D) substrates that is inexpensive, industrially simple and produced in a time-consuming manner; thus providing a composite films of the kind disclosed herein having desired properties, e.g., a desired thickness, homogeneous particle distribution, particle size, flexible, conformal film (i.e., coating which substantially follows the contour of the substrate), excellent electronic conductivity and having essentially no agglomerates within the film structure.

Electrochemical deposition of conformal films of composite materials inside holes with aspect ratio (AR) greater than 1, greater than 5 and even greater than 10, in which the hole diameter is of a few tens of microns, is extremely difficult.

The inventors successfully prepared composite films on planar and 3D substrates having desired properties by electrophoretic deposition (EPD) of conformal films of composite material on a surface region of a planar substrate; and on and throughout a surface region of a three dimensional substrate having a complex geometry, e.g., having perforations or porous structure with high AR of 10-50 where there are holes having a diameter of less than 300 μm and having a length of more than 100 μm.

Such film deposition is considered a major challenge in the field of the invention due to the technical difficulty in conformally depositing electrode materials of the kind disclosed herein, on and throughout the planar substrates; let alone on substrates having complex structures.

Composite films are referred to herein as electrode material (e.g., anode material for energy storage devices) and a ceramic-polymer composite separator material for energy storage devices.

The inventors have recognized that high-quality composite films comprising particles of the kind described herein require stable particle suspensions. However, no known stable suspensions for particles of the kind disclosed herein exist. In the present disclosure, a dispersion has been developed to achieve high quality composite films after re-crystallization, in one aspect, a high stability (in hours) of particles of the kind disclosed herein is achieved, e.g., when referring to anode materials: functionalized porous carbon, graphite, graphene, carbon nanoparticles, carbon nanotubes, carbon fibers, carbon rods, nanowires, fullerenes, silicon particles, silicon oxide particles. When referring to separator materials—polymeric material selected from the group consisting of polyethylene oxide, polyethylene imine, polyethylene imide, polyethylene glycol or any mixture thereof; and a ceramic material selected from the group consisting of alumina, zirconia, cerium oxide particles, YSZ, lithium oxide or any mixture thereof.

In another of its aspects, the present invention provides low-cost, high performance composite materials that can be used in different types of energy storage systems.

Examples of such applications include anodes for lithium ion batteries for electronic devices, automobile and other applications. This invention solves the high preparation cost and the difficulty of practical use in current composite anodes, such as composite silicon anodes.

Thus, there is provided herein, an electrode film obtainable by the method disclosed herein. Alternatively or additionally, there is provided herein, a composite separator film obtainable by the method disclosed herein. In some embodiments, the electrode film (and/or separator) being essentially free of agglomerates. In such embodiments, wherein the agglomerates are not more than 50 μm when determined by scanning electron microscopy at a magnification of 5000 and working distance of 11.6 mm.

In some embodiments, the electrode film (and/or separator) being essentially free of binder.

There is also provided an electrode comprising a substrate and a film, the film comprising particles of a material deposited on a surface region of the substrate; said particles comprise one or more of a functionalized porous carbon, graphite, graphene, carbon nanoparticles, carbon nanotubes, carbon fibers, and carbon rods, nanowires, fullerenes, silicon particles, lithium titanate (LTO) particles; said electrode being for use in an energy storage device and having 200-2000 mAh/g capacity when cycled vs. lithium ion cathode or lithium metal.

As above said, the preparation method of the composite electrode active material (and/or separator) disclosed herein is simple and feasible for industrial mass production; the synthesis process and assembly process of the material are combined into one body through the electrophoretic deposition method disclosed herein.

Typical electrochemical energy storage devices that include an assembly that comprises two electrode layers and an ion-permeable layer, i.e., separator layer disposed therebetween, and an electrolyte ionically connecting both electrodes (herein also referred as: “electrolyte”). The reactants of the cell are subjected to redox reactions. One type of electrochemical energy storage device is a supercapacitor, in which when the electrodes are polarized by an applied voltage, ions in the electrolyte form electric double layers of opposite polarity to the electrode's polarity. As such, positively polarized electrodes have a layer of negative ions at the electrode/electrolyte interface along with a charge-balancing layer of positive ions adsorbing onto the negative layer. The opposite is true for the negatively polarized electrode.

Some examples of energy storage devices that can be utilized by the electrode (and/or separator) of the present invention include any electrochemical energy storage cell, such as a battery, lithium battery, lithium-ion battery, all solid-state lithium-ion battery, supercapacitor, hybrid capacitor, lithium-ion capacitor, ultra-capacitor, solid electrolyte supercapacitor, solid electrolyte hybrid lithium-ion supercapacitor, etc.

When the energy storage device is a battery, the assembly comprises the following components: an anode layer (negative electrode of the present invention), a cathode layer (positive electrode) and a separator layer (herein also referred as: “electrolyte”) disposed therebetween the electrodes. Each of the anode and cathode typically include a current collector, such as aluminum and copper, for the cathode and anode, respectively. The reactants of the cell are subjected to redox reactions.

Methods of preparing an energy storage device include forming a base layer on a substrate, and forming an energy storage stack on the base. The energy storage stack includes at least one joining of separate components of the following layers: two electrode layers, and an electrolyte layer between the anode and cathode. The anode may be the electrode of the present invention. The separator may be the separator of the present invention.

An energy storage system typically includes electrical connectors to the energy storage stack, which are configured for connecting the stack (or multilayer stack of cells) to an electronic device, for example in a battery, anode and cathode electrode connectors are coupled to the anode and cathode layers, respectively.

An additional method of preparing an energy storage device according to the present disclosure is by providing a base layer (for example, aluminum foil) and consecutively forming layers thereon. For instance, forming a cathode layer on the aluminum foil, followed by forming an electrolyte layer thereon, and further followed by forming an anode layer of the present invention on the cathode layer (or by forming an anode layer on a current collector and joining said layer to the electrolyte layer). The forming of the cathode can also be carried out in a reverse order, i.e., by initially forming the anode layer of the present invention, then the electrolyte layer, and then the cathode layer. The forming of the cathode can be carried out by any conventional method known in the art, for example, electrophoretic deposition or simple spreading (e.g., by doctor blade).

The energy storage device of the present invention also includes a “3D electrode cell” designated herein as a cell composed of one of the electrodes coated on electrically conducting substrate, a flat layer of separator or polymer electrolyte coated on the surface of the 3-dimensional electrode and a flat layer of the opposite polarity electrode or alternatively, electric conductive foil or film deposited from both sides.

The use of three-dimensional substrates in comparison to flat substrates results in an increase of the surface area of the substrate. The increase factor is known in the literature as Area Gain (“AG”). For example, the AG of perforated substrates of thickness of 0.1 mm to 5 mm result in an AG of 3-200.

In addition, the device can be a flat flexible battery in which three active layers: cathode, separator of the present invention and the anode of the present invention, are deposited on both sides of electrically conducting thin-film conformably. The resulted electrochemical device can be used as one layer or in winded/rolled configuration.

Such battery configuration can serve as a battery with standard thickness electrodes or with an ultra-thin flexible battery for wearable electronics, energy storage for IoT and surface mounted energy storage devices. The area gain of a foil substrate coated from both sides is referred herein to have an AG of 2.

A flat substrate is referred to herein as a substrate having an AG of 1. Some non-limiting examples of flat substrates include, metals such as nickel, aluminum, stainless steel, copper and gold); metal fabrics; polymers such as polyethylene terephthalate (PET), polydimethylsiloxane (PDMS), polyamide (Nylon), polyethylene (PE), polypropylene (PP), poly (methyl methacrylate) (PMMA), polystyrene (PS), polytetrafluorethylene (PTFE), polyvinylchloride (PVC), polyurethane (PU), polycarbonate (PC); carbon material such as carbon fiber mat, carbon nanotubes mat, carbon fabric and carbon paper.

As above mentioned, the energy storage system according to the present invention includes a lithium-ion rechargeable battery.

According to the present invention, the electrolyte comprises a solvent suitable for reducing a material to form an insoluble solid electrolyte interphase (SEI) on the anode surface. Such solvents include aprotic solvents such as ethylene carbonate (EC), diethylcarbonate (DEC), dimethylcarbonate (DMC), ethyl methyl carbonate (EMC), butyl carbonate, propylene carbonate, vinyl carbonate, dialkylsulfites and any mixtures thereof. In addition, metal salts known in the art to be suitable as good SEI precursors include: LiPF₆, LiBF₄, LiAsF₆, LiCF₃, and LiN(CF₃SO₂)₂, LiCF₃SO₃, LiI, LiBOB, vinyl carbonate (VC) and LiBr.

In some embodiments, the lithium-ion battery disclosed herein comprises a liquid electrolyte. For example, the liquid electrolyte can comprise an aprotic solvent from the above-mentioned list and a lithium salt, such as LiPF₆.

In some embodiments, the liquid electrolyte comprises at least one lithium salt in an organic solvent.

In such embodiments, the organic solvent comprises at least one of: ethylene carbonate, dimethyl carbonate, diethyl carbonate, ethyl methyl carbonate, butyl carbonate, propylene carbonate, vinyl carbonate, dialkylsulfites and fluoroethylene carbonate.

In further embodiments, the liquid electrolyte comprises an ionic liquid.

Ionic liquids as used herein are salts with organic components and are liquids at temperatures below 100° C. They are highly stable, with almost no vapor pressure and are thus non-volatile. The presence of the cation tends to give ionic liquids high ionic conductivity, making them excellent replacements for conventional battery liquid electrolytes. Some non-limiting examples include, an ionic liquid comprising 1-ethyl-3-methyl imidazolium, 1-Butyl-3-methylpyridinium bis (trifluormethylsulfonyl), 1-Butyl-1-methylpyrrolidinium bis(fluorosulfonyl)imide, 1-Methyl-1-(2-methoxyethyl)pyrrolidinium bis(fluorosulfonyl)imide, 1-Ethyl-3-methylimidazolium tetrafluoroborate, N-ethyl-N-methylpiperidinium bis(fluorosulfonyl)imide.

In some other embodiments, the lithium-ion battery disclosed herein comprises a solid or gel polymer electrolyte. Namely, a polymer electrolyte contains a polymer, preferably polyethylene oxide, adapted to form a complex with the metal salt (for example, from the above-mentioned list), and optionally, a nano-size ceramic powder to form a composite polymer electrolyte.

As mentioned above, the energy density and specific energy of flexible batteries, which express the energy capacity of the battery per unit volume and weight, respectively, are important performance parameters, and consequently, it is desirable to increase the energy density and specific energy of such batteries. By utilizing the electrode of the present invention in an energy storage device, a high volumetric energy density and specific energy of such devices is obtained.

In some embodiments, the energy storage device, having a volumetric energy density of at least 200 mAh per liter (mAh/l) when said battery module is discharged at a current of 0.01 mA/cm2.

In some embodiments, the battery device, having a gravimetric energy density of at least 40 mAh per g (mAh/g) [measured via charging to nominal voltage and discharging to 50% of the nominal voltage or to 0.1V vs. lithium.

Additionally or alternatively, the electrode film (and/or separator) having no gaps between different components of the material when viewed at a magnification revealing structures above about 0.1 μm.

Also peel tests are a common tool for measuring the adhesion of the electrode film (and/or separator) to the substrate. The “scotch test tape” qualitative tests the adhesion of a film deposited on a substrate by applying a piece of pressure sensitive tape to the film and pulling the tape off. If the top layer of the deposited film comes off (either in parts or in pieces), it is said to have “failed” the test. The adhesion force of the electrode film can also be determined using a load cell connected to the free end of a film which is then pulled at a 90° angle to a fixed substrate or 180° to a second attached flexible film, to measure force required to separate the film from a substrate. The peel strength is defined as the average load per unit width of bond-line required to progressively separate the two materials.

The present invention also provides an electrode film (and/or separator) being void-free. In accordance with the present invention, the term “void-free” refers to electrode particles formed (e.g., deposited) on the surface that are very closely associated with the surrounding medium such that gaps, if any, are of a size (width) of less than 0.1 μm, when observed, inter alia, by scanning electron microscopy, or by other suitable techniques known in the art for revealing such gaps.

Some non-limiting examples of binders that may be included in the electrode of the invention include polymers or co-polymers: cellulose based polymers, polyethylene oxide, Polyvinylidene fluoride (PVDF), Polyethylene oxide (PEO), Polyethylenimine (PEI), Polyvinyl chloride (PVC), Polytetrafluoroethylene (PTFE), composites of orthosilicate polymer derivatives, sodium/lithium carboxy methyl cellulose (NaCMC/LiCMC), cellulose based binder and poly-methyl methacrylate (PMMA. The electrode film comprises a material including, but not limited to, graphite, graphite infused with lithium ions, silicon, silicon carbon composite, nano particles, silicon nanotubes or carbon-silicon composite agglomerates, tin and tin oxide particles, graphene, hard carbon, lithium, lithium titanium oxide (LTO). For symmetric supercapacitor or ultra-capacitor: activated carbon from natural source such as coconut, tar, wood, tobacco leaves, plants, organic polymers.

In some embodiments, the silicon particles comprises a material selected from silicon oxide particles, silicon nanowires, silicon nanotubes, silicon microparticles and silicon nanoparticles.

In some embodiments the electrode comprising carbon to silicon in a molar ratio between about 1:10 to 10:1.

In some embodiments, the electrode wherein the carbon is in the form selected from a graphite, a graphene, a carbon nanoparticle, a carbon nanotube, a carbon fiber and a carbon rod.

In another embodiment, the electrode wherein the silicon is in the form selected from Si powder, an Si nanowire, an Si nanoparticle, an Si sol particle, and an Si rod.

In some embodiments, the electrode (and/or separator) being essentially homogeneous.

In some embodiments, the electrode (and/or separator) being flexible.

In some embodiments, the electrode film (and/or separator) is essentially free of agglomerates.

In such embodiments, the agglomerates are not more than 50 μm in diameter when determined by scanning electron microscopy at a magnification of 5000 and working distance of 11.6 mm.

In some embodiments, the electrode film (and/or separator) is essentially free of binder.

In some embodiments, the substrate is planar. In some embodiments, the substrate is a perforated 3D substrate.

In some embodiments, the substrate comprises or is composed of a conductive material selected from silver, gold, copper, aluminum, nickel, stainless steel, titanium, conductive paper, conductive fibers, porous conductive support and a conductive polymer.

In some embodiments, the film comprises particles at a loading density of 0.5-20 mg/cm2.

The electrode (and/or separator) further comprises a binder having a concentration of 0-15% w/w and conducting additives having a concentration of 0-15% w/w.

Some non-limiting examples of conducting additives that may be included in the electrode of the invention include carbon black, multi-wall carbon nanotubes (MWCNT), single-wall carbon nanotubes (SWCNT), graphene flakes, graphene oxide flakes, activated carbon and graphite.

It is a further object of the present invention to provide an energy storage device comprising the electrode (and/or separator) disclosed herein (for example, a three-dimensional microbattery) having at least one of a high-power density, high capacity and high energy density.

The above objects are achieved by the present invention, by utilizing a substrate having throughout perforations in the substrate's structures (referred herein also as: three-dimensional substrate or three-dimensional battery). The use of such a substrate increases the available area for thin-film deposition, thus leading to an increase in volume, i.e., increase in the capacity of the cell. In some embodiments, the energy storage device being an on-chip battery.

In some embodiments, the energy storage device is a symmetrical or hybrid supercapacitor comprising two electrodes and separator impregnated with electrolyte.

The hybrid supercapacitor comprises lithium ion cathode as positive polarity and activated carbon as the negative polarity comprising the electrode of the invention.

In some embodiments, the energy storage device, battery or supercapacitor, is in the form of at least two stacked cells connected in parallel or series. In a stacked configuration, the cells arranged on top of each sequential cell or next to each other. The above electrochemical device is connected, in the series configuration, to the electric circuit from one polarity of the first cell to the opposite polarity of the last cell in stack and in the parallel configuration each cell in the stack is connected to the circuit by both positive and negative port. In both parallel and series configurations the cells are balanced passively by weight balance of the cell electrodes or by active BMS device.

As above mentioned, the present invention provides low-cost, high performance electrodes that can be used in different types of energy storage systems. Examples of such applications include anodes for lithium ion batteries for electronic devices, automobiles and other applications.

Thus, in some embodiments, there is provided an energy storage device comprising at least one electrode (and/or separator) described herein.

In some embodiments, the electrode (and/or separator) being for use in an energy storage device. In some embodiments, the energy storage device is for use in one or more of Li ion batteries, solar absorbers, thin film transistors, solar cells and supercapacitors. In some embodiments, the energy storage device is for use in Li ion batteries and/or supercapacitors. In some embodiments, the energy storage device is for use in Li ion batteries.

The present invention is also directed to a novel electrophoretic deposition suspension to obtain high quality electrode films (and/or separator films.

Thus, in yet another of its aspects, the present invention discloses a dispersion comprising: (i) a solvent selected from acetone, isopropanol, ethanol, acetonitrile; (ii) a charger agent; and (iii) a plurality of particles comprising one or more of a functionalized porous carbon, graphite, graphene, carbon nanoparticles, carbon nanotubes, carbon fibers, carbon rods, nanowires, fullerenes, silicon particles, silicon oxide particles, the charger agent and said plurality of particles being dispersed in said organic solvent; the dispersion having a ratio between the charger agent and the plurality of particles between 1:2 to 1:4% w/w; and the dispersion being for use in electrophoretically depositing an electrode active material.

In some embodiments, the dispersion comprises charged particles essentially consisting of silicon particles. In some embodiments, the dispersion consisting essentially of an organic solvent including an aprotic, non-polar organic solvent; aprotic, polar organic solvent; a ketone or a combination thereof; and a plurality of nanoparticles, where the plurality of particles comprise an silicon, alloyed silicon, or silicon oxide particles. In one embodiment, the particles are Si particles. In some embodiments, the dispersion is a stable nanoparticle dispersion. In some embodiments, the dispersion is stable for at least 30 hours.

In some embodiments, the dispersion is stable and essentially without additives, such as binder.

In some embodiments, the method wherein the ratio between the charged particles and the charger agent is between 1:5 to 5:1% w/w.

In some embodiments, the method wherein the ratio between the charged particles and the charger agent is between 2:1 to 4:1% w/w.

In some embodiments, the method wherein the ratio between the charged particles and the charger agent is 3:1% w/w.

In some embodiments, the method wherein the silicon particles comprises a material selected from silicon oxide particles, silicon nanowires, silicon nanotubes, silicon microparticles and silicon nanoparticles.

In some embodiments, the method wherein the solvent is aqueous-based.

In some embodiments, the method wherein the solvent is an organic solvent selected from the group of an aprotic, non-polar organic solvent; aprotic, polar organic solvent; and a ketone.

In some embodiments, the method wherein the organic solvent is selected from the group of ethanol, propanol and isopropanol.

In some embodiments, the method wherein the charger agent is selected from the group of amines, nitrates, nitrites, chlorides, chlorates and iodides.

In some embodiments, the method wherein the amine is trimethylamine.

In some embodiments, the method wherein the charger agent is magnesium nitrate.

In some embodiments, the method wherein the dispersion further comprises at least one additive selected from a wetting agent, a surfactant and a dispersant.

In some embodiments, the method wherein the additive is selected from TritonX100™ (polyethyleneglycol tert-octylphenyl ether), polyethyleneimine, pluronic F-127, polyetherimide.

In some embodiments, the method wherein the voltage applied in order to induce an electrical current sufficient to deposit on the substrate an anode film (and/or separator film) comprising nanoparticles is between 30V to 120V.

In such embodiments, the voltage is between 50V to 110V, at times, between 70V to 110V, at times between 80V to 110V, at times between 80V to 100V.

In some embodiments, the method wherein the substrate is planar. In some embodiments, the method wherein the substrate is a perforated 3D substrate.

In some embodiments, the method wherein the substrate comprises or is composed of a conductive material selected from silver, gold, copper, aluminum, nickel, stainless steel, titanium, conductive paper, conductive fibers, porous conductive support, conductive polymer and metalized plastic.

In some embodiments, the method wherein the dispersion is essentially free of binder.

In some embodiments, the method wherein the electrophoretic deposition is cathodic electrodeposition or anodic electrophoretic deposition. In some embodiments, the method wherein the electrophoretic deposition is cathodic electrodeposition.

In yet another of its aspects, the present disclosure provides a method for electrophoretically depositing a composite insulating ceramic material on a substrate, the method comprising: i) providing a dispersion comprising a solvent, said dispersion comprising a charger agent and charged particles dispersed therein; ii) applying an electrical current sufficient to deposit a film comprising the particles on a surface region of the substrate; said particles comprise one or more of a polymeric material selected from the group consisting of polyethylene oxide, polyethylene imine, polyethylene imide, polyethylene glycol or any mixture thereof; and a ceramic material selected from the group consisting of alumina, zirconia, cerium oxide particles, YSZ, lithium oxide or any mixture thereof; and said ratio between the charged particles and the charger agent is between 10:1 to 100:1% w/w.

In some embodiments, the method wherein said polymeric material is PVDF and said ceramic material is alumina. In some embodiments, the method wherein the concentration of said polymeric material and said ceramic material is between 5 to 10 g/l and 0.2 to 1.5 g/l, respectively.

### DETAILED DESCRIPTION OF EMBODIMENTS (PACKAGING ELEMENT)

### Examples 1 and 2: Fabrication of Thin-Film Battery Comprising the Packaging Element According to Some Embodiments of the Present Invention (Consecutive Layers)

Two samples were prepared by electrophoretic deposition (EPD) of LiCoO₂ cathode on a substrate, polymer-ceramic separator (alumina and PVDF binder) and graphite anode. Example 1 was prepared on an aluminum substrate and Example 2 was prepared on a conducting fiber composed of 57% polyester, 23% copper and 20% nickel.

Two additional samples of a neat aluminum substrate (Example 3) and a neat conducting fiber substrate (Example 4) were also taken as reference samples and deposited with parylene layer.

Each sample was marked using a marker prior to parylene deposition.

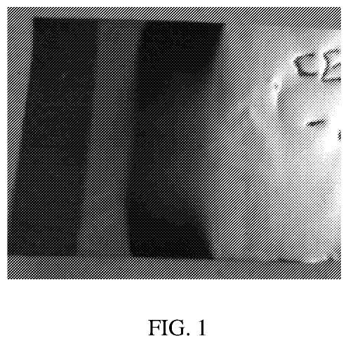

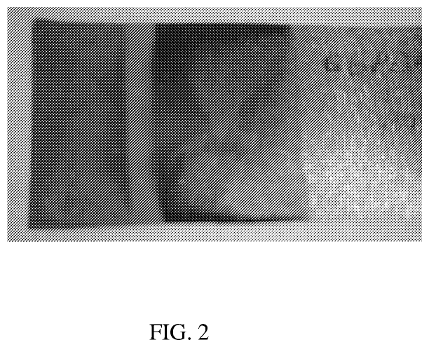

FIG. 1 shows a thin-film battery comprising the packaging element according to Example 1 of the present invention and FIG. 2 shows a thin-film battery comprising the packaging element according to Example 2 of the present invention.

Deposition of Thin-Film Battery of Example 1 with a Parylene Packaging Element Parylene polymers were deposited at pressures of about 0.1 torr, thereby providing a mean free path of the gas molecules in the deposition chamber on the order of 0.1 cm.

All sides of the battery are uniformly impinged by the gaseous monomer resulting in a truly conformal, pinhole-free coating. The parylene deposition process consists of three distinct steps: (i) vaporization of solid dimer at approximately 150° C.; (ii) pyrolysis of the dimer vapor at the two methylene-methylene bonds at about 680° C., which yields the stable monomeric diradical, para-xylylene; (iii) the monomeric vapor enters the room temperature deposition chamber where it spontaneously polymerizes on the substrate.

Penetration Test:

Neat samples on aluminum substrate and on a neat conducting fiber substrate according to Example 3 and Example 4 of the invention were tested for solvent penetration through the parylene packaging layer. The solvents used were acetone and commercial electrolyte 1M LiPF₆ Ethylene carbonate and dimethyl carbonate in 1:1 volume ratio. Each sample was placed individually in an hermetically sealed flask in both solvents for 1 hours at temperatures of: (i) room temperature, (ii) 60° C. The marks did not substantially erase on all of the samples.

### Examples 5 and 6: Fabrication of Thin-Film Battery Comprising the Packaging Element According to Some Embodiments of the Present Invention (Joining of Layers)

LiCoO₂ cathode layer was prepared by EPD on an aluminum substrate, graphite anode was prepared by EPD or by doctor-blade, and Celgard® (25 μm thick) separator layer was disposed between the anode and cathode layers. Example 5 was prepared on an aluminum substrate and Example 6 was prepared on a conducting fiber composed of 57% polyester, 23% copper and 20% nickel.

A full cell was assembled by joining the above components (cathode, separator, anode) together.

A needle was positioned between the layers for impregnating a liquid electrolyte within the separator layer inside the cell.

Parylene packaging layer was deposited according to the procedure described in Example 1 and Example 2 above.

Electrolyte Leakage Test:

Electrolyte comprising 1M LiPF₆ Ethylene carbonate and dimethyl carbonate in 1:1 volume ratio, 0.5 ml was inserted through the needle in the sample detailed in Example 5 (the cell was covered with parylene packaging element of the invention).

The sample was kept at room temperature for 7 days. No electrolyte leakage was noticed from the sample.

### Example 7: Electrophoretic Deposition of Composite Graphene and Silicon-Graphene Anode from Aqueous Electrophoretic Bath

Stable graphene colloids modified by oxidation product of p-phenylene diamine (OPPD) is synthesized. Exfoliated graphen oxide (rGO)/graphene oxide (GO) is prepared from natural graphite. The graphitic oxide was prepared by adding powdered flake graphite and of sodium nitrate in the weight ratio of 2:1 into sulfuric acid.

Potassium permanganate in the weigh ration of 3:1 to graphitic oxide was added to the suspension. After 30 minutes, the suspension was diluted and treated with hydrogen peroxide to reduce the residual permanganate and manganese dioxide to colorless soluble manganese sulfate. The suspension was filtered to collect the graphitic oxide.

GO in the concentration of 0.5-2 g/l in water is mixed and sonicated with 5-10 g/l of p-phenylene diamine (PPD) dissolved in N,N dimethylformamide (DMF) or Triton X 100 surfactant. The colloid and the solution is mixed and refluxed in a water bath at 90° C. for 24 hours to form rGO The silicon nano powder is oxidized and charged by mixing 0.1-5 g/l silicon nano powder in 1:10 v/v HF:water solution. The electrophoretic bath contained 0.1-5 g/l graphene oxide and 0.1-1 g/l silicon oxide, 0-1% v/v surfactant agent and 3-50 mM iodine (I₂) dispersed in ethanol, acetone or isopropanol by ultra-sonication.

Silicon-graphene composite anode films are obtained by electrophoretic cathodic deposition. The deposition voltage is 10-100V. The thickness of the layer is controlled by the deposition time, concentration of the deposited particles in the bath, applied effective voltage, electrode surface area and the particle mobility in the suspension. The resulted composite anode is plated on electron conducting substrate or on separator layer.

### Example 8: Electrophoretic Deposition of Composite Graphene and Silicon-Graphene Anode from Organic Solvent Electrophoretic Deposition Bath

The electrophoretic bath contained 0.1-5 g/l graphene oxide (prepared as described in Example 7) and 0.1-5 g/l silicon oxide (treated as described in Example 7), 0-1% v/v surfactant agent and 0.01-0.5 g/l iodine (I₂) 0.001-0.5 g/l Mg(NO₃)₂ or TEA dispersed in acetone based solution (ethanol, isopropanol, DDH₂O or acetone) by ultra-sonication.

Silicon-graphene composite anode films are obtained by electrophoretic cathodic deposition (for the I₂ and Mg based charger) or anodic deposition (based of TEA charger). The deposition voltage is 10-100V. The thickness of the layer is controlled by the deposition time, concentration of the deposited particles in the bath, applied effective voltage, electrode surface area and the particle mobility in the suspension. The resulted composite anode is plated on electron conducting substrate or on separator layer.

### Example 9: Electrophoretic Deposition of Composite Graphene and Silicon-Graphene Anode from Organic Solvent Electrophoretic Deposition Bath-Iodine Based Bath

The electrophoretic bath contained 0.01-5 g/l surfactant coated CNTs (multi wall, double wall and single wall) and 0.1-5 g/l silicon micro particles, 0-1% v/v surfactant agent and 0.01-0.5 g/l iodine (I₂) dispersed in acetone based solution (ethanol, isopropanol, DDH₂O or acetone) by ultra-sonication.

Silicon-MWCNT composite anode films are obtained by electrophoretic cathodic deposition. The deposition voltage is 10-100V. The thickness of the layer is controlled by the deposition time, concentration of the deposited particles in the bath, applied effective voltage, electrode surface area and the particle mobility in the suspension.

The resulted composite anode is plated on electron conducting substrate or on separator layer.

### Example 10: Electrophoretic Deposition of Activated Carbon Electrodes for Symmetrical Supercapacitor from Organic Solvent Electrophoretic Deposition Bath

The electrophoretic bath contained 0.01-5 g/l surfactant coated CNTs (multi wall, double wall and single wall) and 0.1-5 g/l activated carbon powder, 0-1% v/v surfactant agent and 0.01-0.5 g/l iodine (I₂) dispersed in acetone based solution (ethanol, isopropanol, DDH₂O or acetone) by ultra-sonication.

Activated carbon films are obtained by electrophoretic cathodic deposition. The deposition voltage is 10-100V. The thickness of the layer is controlled by the deposition time, concentration of the deposited particles in the bath, applied effective voltage, electrode surface area and the particle mobility in the suspension. The resulted composite electrode is plated on electron conducting substrate or on separator layer.

### Example 11: Supercapacitor Prepared Via Electrophoretic Deposition of Graphene/Activated Carbon/MnO₂ Composite

MnO₂ powder in the concentration of 5-50 g/l in water was mixed and sonicated with 0.1-1 g/l of phosphate ester (PE) dissolved in ethanol. 0.1-1 g/l graphene oxide, after activation with PPD as described in Example 7, were added to the EPD bath. In addition, activated carbon with particle size of 1-10 micro meter was added in the concentration of 0-1 g/1 and 0-1% v/v surfactant agent was added.

The colloid and the solution were mixed and a stable colloid in ethanol will be formed by ultra-sonication. Composite manganese oxide cathode films were obtained by electrophoretic cathodic deposition. The deposition voltage will be 80-100V.

A separator layer was formed on the cathode layer by electrophoretic deposition described in Example 12. The anode layer of activated carbon was deposited on the separator layer according Example 10.

The thickness of the layers was controlled by the deposition time, concentration of the deposited particles in the bath, applied effective voltage, electrode surface area and the particle mobility in the suspension.

### Example 12: Electrophoretic Deposition of Separator Layer for Lithium Ion Battery or Organic Electrolyte Based Supercapacitor from Organic Solvent EPD Bath

The electrophoretic bath contained 0-1 g/l alumina dispersed powder and 0.1-5 g/l Polyvinylidene fluoride (PVDF), 0-1% v/v surfactant agent and 0.01-0.5 g/l iodine (I₂) dispersed in acetone based solution (ethanol, isopropanol, DDH₂O or acetone) by ultra-sonication.

Separator films are obtained by electrophoretic cathodic deposition. The deposition voltage is 10-100V. The thickness of the layer is controlled by the deposition time, concentration of the deposited particles in the bath, applied effective voltage, electrode surface area and the particle mobility in the suspension. The resulted composite electrode is plated on electron conducting substrate or on separator layer.

Another issue involves the anode, which is known to typically expand and contract during the charge and discharge cycles of the battery. Flexible packaging film known in the art are prone to such expansion, thus resulting in mechanical stresses in the anode which eventually lead to mechanical or chemical failure and reduce the lifetime or degrade performance of the energy storage device (e.g., battery). Such packaging is typically thick and/or heavy, thus reducing the energy density and specific energy of the energy storage device.

Packaging system for energy storage systems, such lithium ion batteries should provide a barrier against the penetration of air and water vapors from one hand, and from the other hand should be inert to any of the internal ingredients of the energy storage device, especially these that are in direct contact with the packaging, such as the electrolyte, the electrolyte solution, the current collectors, the electrodes components and the separator components, (stack) e.g. it should provide sufficient sealing and non-reactive properties for the entire cycle life of the energy storage system. Moreover, since in part of the cycle life of lithium ion batteries, but not limited to, due to the intercalation and/or alloying of lithium in the active materials, small volume changes occur, and in some cases, especially, but not only, during the initial formation sequence, gas evulsion occurs due to chemical reactions such these which are building the solid electrolyte interface (SEI). These volume changes are systematical and therefore, the packaging/sealing should also be able to stretch along with the stack volume changes.

Most of current available energy storage devices use various forms of sealing methods, among which are polymer readymade pouches, various shapes hard protective coatings such as metal, plastic materials etc. While the former might have flexibility, still all the above sealing methods are thick, where in most cases, the thinnest pouches are approximately 100-125 micrometer, and having two sides for each battery, the minimum total thickness that the pouches contributes to the energy storage system is approx. 200 micrometers.

Some embodiments of some aspects of the invention provide an improved method for depositing a thin-film layer comprising a polymer, for sealing an energy storage device (e.g., thin-film battery). For example, some embodiments of the invention provide a method of coating an energy storage device with a protective thin-film barrier layer against penetration of air and/or water vapor into the device, which may eventually cause degradation of one or more of the device's components (e.g., lithium anode in a battery). Such methods are particularly advantageous in flexible energy storage devices, which require flexible and efficient protective packaging materials. However, there are many challenges in such an industrially applicable, easy to manufacture and inexpensive method. Some embodiments of the invention provide a unique roll to roll method for producing a thin-film sealing layer on an energy storage device, e.g., less than 125 μm, or less than 100 μm, or less than 60 μm, or even less than 40 μm. Optionally, the method is an industrial method. In some embodiments, the method is a single-step or a multi-step coating method that can form an essentially sealed, optionally void-free enclosure of the energy storage device, e.g., lithium ion batteries and/or capacitors. The method may be suitable for sealing solid-state and/or liquid energy storage devices.

The method is based on polymer vapor phase deposition process. The process starts with a solid or liquid monomer/dimer rather than a polymer and, in commercial equipment, polymerizes it on the surface of an object. To achieve this the monomer/dimer first goes through a two-step heating process. The solid or liquid monomer/dimer is converted to a reactive vapor of the monomer/dimer and then, when passed over room temperature objects, the vapor will condense as a polymeric coating.

The sealing is carried out by providing a packaging element comprising a polymer; in which the packaging element has, in some cases, a total thickness of 25 μm to 50 μm and yet still provides an essentially sealed, void-free enclosure of a lithium ion battery, namely, hermetically sealing of the lithium ion battery by providing a thin polymeric encapsulate extending continuously around the faces of the lithium ion battery so that no contaminants (such as, air, water vapor, gases, electrolyte) can penetrate into or escape from the system. Thus, the packaging element enables obtaining a lithium ion battery that is moisture-resistant. The packaging element also allows the electrodes to change volume during operation of the energy storage device (i.e., during charge and discharge), and thus, enables operation of the energy storage device during prolonged cycling.

Polymerization Mechanisms Polymers are often classified based on the polymerization kinetics used to produce the polymer. According to this scheme, all polymerization mechanisms are classified as either step growth or chain growth. A step growth polymerization is one that is defined to have a random reaction of two molecules that may be any combination of a monomer, an oligomer (polymer chain with less than 10 units), or a long-chain molecule. A chain growth polymerization is one that is defined to have a polymer chain that grows only one unit at a time, by the attachment of a monomer to a chain end. The chain end could be a radical, cation, or anion. Chain growth polymerization takes place in three common steps-initiation, propagation, and termination. Parylene polymerization is of the chain growth type except that the chains are not terminated during growth. Un-reacted chain ends are buried in the film as it grows. Subsequent termination of the radical chain ends can occur post-deposition via reactions such as with atmospheric oxygen that has diffused into the polymer film.

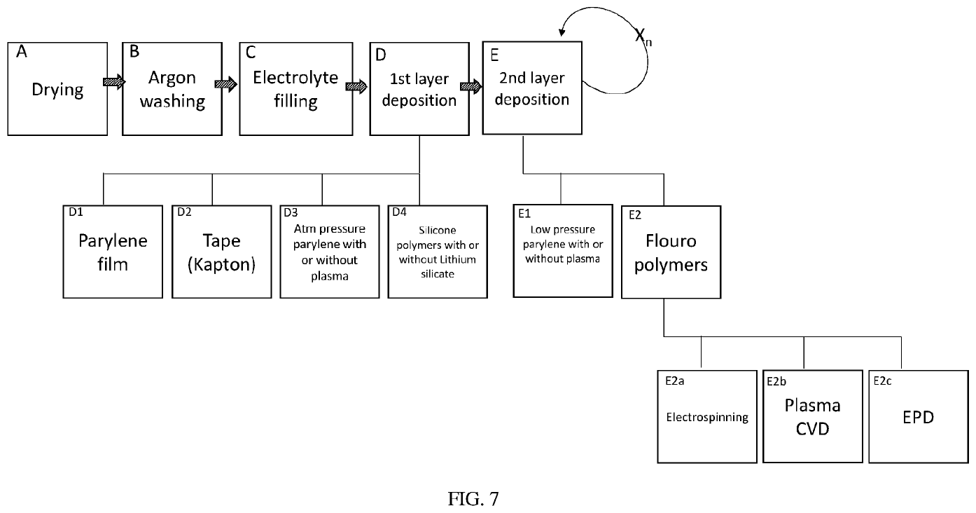

FIG. 7 represents a multi-step coating & sealing procedure according to some embodiments of the method of the invention, in which some of the sealants may be, but not limited to Parylene, Kapton, Silicon polymers with or without lithium silicates or lithium metasilicates. The sealing method comprises a scheme flow as follows:

A. Drying:

Electrodes stack which may includes anodes, separators, and cathodes, are dried to lithium ion battery compatible level. In most cases this step is taking place under vacuum.

This step takes place only if drying is necessary, for example in commonly used lithium ion batteries, however in some embodiments, this is not a necessary step.

B. Environmental Gas Change to Dry Argon Environment (Argon Washing/Insertion from Vacuum Surrounding into an Argon Chamber):

This step is preliminary to insertion of electrolyte solution by spraying (for example), of the stack with the amount of electrolyte solution needed for the energy storage system.

In some cases, if the electrolyte is deposited by injection, this process is not necessary, as long as the electrolyte solution is not exposed to ambient air in case that the electrolyte solution is sensitive to ambient air and moisture.

If the electrolyte solution and the stack is not sensitive to moisture, this step can also be eliminated.

C. Electrolyte Filling:

This can be done by direct spraying of the electrolyte solution on the electrode stack, or by injection, or any other method which will give to the stack the appropriate amount of electrolyte solution for the future correct operation of the energy storage device.

D. 1st Sealing Layer Deposition:

This stage is meant to create the 1^{st} protective layer directly on a liquid contained stack (e.g. electrolyte solution) and protect the electrolyte before the next stage.

This layer can be:

D1. Parylene film

D2. Kapton/PET Tape (or other tape which is not reactive toward the stack & electrolyte solution.

D3. Atmospheric pressure Parylene deposition with or without plasma

D4. Silicone polymer with or without lithium silicate/lithium metasilicate.

E. 2nd Sealing Layer Deposition:

This stage is aimed to increase the thickness and stability, and perfect the sealing layer to be suitable for the energy storage device needs.

This can be done in:

E1. Low pressure Parylene deposition with or without plasma

E2. Fluoro polymers in several methods:

E2a. Electro spinning

E2b. Plasma CVD

E2c. electrophoretic deposition (EPD)

E can be repeated n times with the same or different substances.

### DETAILED DESCRIPTION OF EMBODIMENTS (ELECTROPHORETIC DEPOSITION)

### Example 1: Electrophoretic Deposition of Composite Graphene and Silicon-Graphene Anode from Aqueous Electrophoretic Bath

Stable graphene colloids modified by oxidation product of p-phenylene diamine (OPPD) is synthesized. Exfoliated graphite oxide (GO)/graphene oxide is prepared from natural graphite. The graphitic oxide was prepared by adding powdered flake graphite and of sodium nitrate in the weight ratio of 2:1 into sulfuric acid. Potassium permanganate in the weigh ration of 3:1 to graphitic oxide was added to the suspension. After 30 minutes, the suspension was diluted and treated with hydrogen peroxide to reduce the residual permanganate and manganese dioxide to colorless soluble manganese sulfate. The suspension was filtered to collect the graphitic oxide. GO in the concentration of 0.5-2 g/l in water is mixed and sonicated with 5-10 g/l of p-phenylene diamine (PPD) dissolved in N,N dimethylformamide (DMF) or Triton X 100 surfactant. The colloid and the solution is mixed and refluxed in a water bath at 90° C. for 24 hours.

The silicon nano powder is oxidized and charged by mixing 0.1-5 g/l silicon nano powder in 1:10 v/v HF:water solution. The electrophoretic bath contained 0.1-5 g/l graphene oxide and 0.1-1 g/l silicon oxide, 0-1% v/v surfactant agent and 3-50 mM iodine (I₂) dispersed in ethanol, acetone or isopropanol by ultra-sonication.

Silicon-graphene composite anode films are obtained by electrophoretic cathodic deposition. The deposition voltage is 10-100V. The thickness of the layer is controlled by the deposition time, concentration of the deposited particles in the bath, applied effective voltage, electrode surface area and the particle mobility in the suspension.

The resulted composite anode is plated on electron conducting substrate or on separator layer.

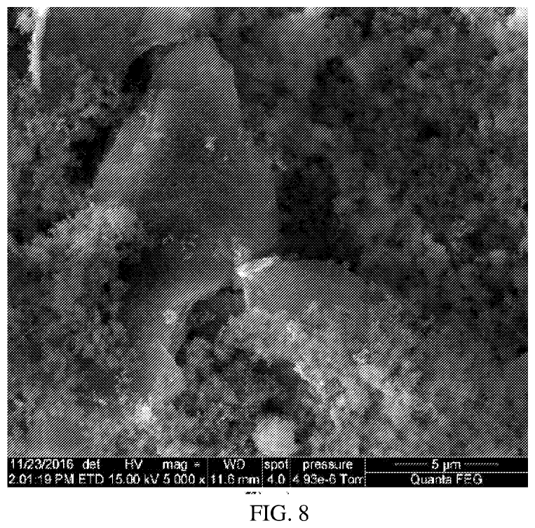

SEM image of the composite graphite anode is displayed in FIG. 8, at a magnification of ×5,000 and working voltage of 15 kV (according to Example 1 above).

### Example 2: Electrophoretic Deposition of Composite Graphene and Silicon-Graphene Anode from Organic Solvent Electrophoretic Deposition Bath

The electrophoretic bath contained 0.1-5 g/l graphene oxide (prepared as described in Example 1) and 0.1-5 g/l silicon oxide (treated as described in Example 1), 0-1% v/v surfactant agent and 0.01-0.5 g/l iodine (I₂) 0.001-0.5 g/l Mg(NO₃)₂ or TEA dispersed in acetone based solution (ethanol, isopropanol, DDH₂O or acetone) by ultra-sonication.

Silicon-graphene composite anode films are obtained by electrophoretic cathodic deposition (for the I₂ and Mg based charger) or anodic deposition (based of TEA charger). The deposition voltage is 10-100V. The thickness of the layer is controlled by the deposition time, concentration of the deposited particles in the bath, applied effective voltage, electrode surface area and the particle mobility in the suspension.

The resulted composite anode is plated on electron conducting substrate or on separator layer.

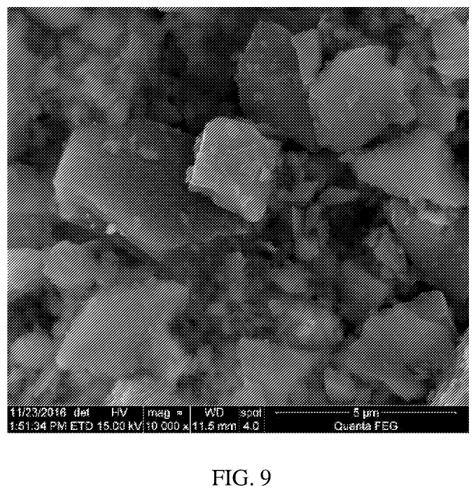

FIG. 9 is a SEM image of a silicon anode according to Example 2 according to some embodiments of the present invention relating to electrophoretic deposition.

### Example 3: Electrophoretic Deposition of Composite Graphene and Silicon-Graphene Anode from Organic Solvent Electrophoretic Deposition Bath-Iodine Based Bath

The electrophoretic bath contained 0.01-5 g/l surfactant coated CNTs (multi wall, double wall and single wall) and 0.1-5 g/l silicon micro particles, 0-1% v/v surfactant agent and 0.01-0.5 g/l iodine (I₂) dispersed in acetone based solution (ethanol, isopropanol, DDH₂O or acetone) by ultra-sonication.

Silicon-MWCNT composite anode films are obtained by electrophoretic cathodic deposition. The deposition voltage is 10-100V. The thickness of the layer is controlled by the deposition time, concentration of the deposited particles in the bath, applied effective voltage, electrode surface area and the particle mobility in the suspension.

The resulted composite anode is plated on electron conducting substrate or on separator layer.

### Example 4: Electrophoretic Deposition of Activated Carbon Electrodes for Symmetrical Supercapacitor from Organic Solvent Electrophoretic Deposition Bath

The electrophoretic bath contained 0.01-5 g/l surfactant coated CNTs (multi wall, double wall and single wall) and 0.1-5 g/l activated carbon powder, 0-1% v/v surfactant agent and 0.01-0.5 g/l iodine (I₂) dispersed in acetone based solution (ethanol, isopropanol, DDH₂O or acetone) by ultra-sonication.

Activated carbon films are obtained by electrophoretic cathodic deposition. The deposition voltage is 10-100V. The thickness of the layer is controlled by the deposition time, concentration of the deposited particles in the bath, applied effective voltage, electrode surface area and the particle mobility in the suspension. The resulted composite electrode is plated on electron conducting substrate or on separator layer.

### Example 5: Supercapacitor Prepared Via Electrophoretic Deposition of Graphene/Activated Carbon/MnO₂ Composite

MnO₂ powder in the concentration of 5-50 g/l in water was mixed and sonicated with 0.1-1 g/l of phosphate ester (PE) dissolved in ethanol. 0.1-1 g/l graphene oxide, after activation with PPD as described in Example 4, were added to the EPD bath. In addition, activated carbon with particle size of 1-10 micro meter was added in the concentration of 0-1 g/1 and 0-1% v/v surfactant agent was added.

The colloid and the solution were mixed and a stable colloid in ethanol will be formed by ultra-sonication. Composite manganese oxide cathode films were obtained by electrophoretic cathodic deposition. The deposition voltage will be 80-100V.

A separator layer was formed on the cathode layer by electrophoretic deposition. The anode layer of activated carbon was deposited on the separator layer according to Example 4.

The thickness of the layers was controlled by the deposition time, concentration of the deposited particles in the bath, applied effective voltage, electrode surface area and the particle mobility in the suspension.

### Example 6: Electrophoretic Deposition of Polyvinylidene Fluoride (PVDF) Based Separator Composite

A cathodic electrophoretic deposition process was used to deposit polyvinylidene fluoride (PVDF) based separator. In order to deposit the separator layer via electrophoretic process, solid iodine (I₂) was added as charger. According to reactions (1) and (2) iodine and acetone react via the following mechanism to produce hydronium ions, which in turn serve as chargers:

CH₃C(O)CH₃↔CH₃C(OH)CH₂ (1)

CH₃C(OH)CH₂+I₂↔CH₃COCH₂I+H⁺+I⁻ (2)

Separator coatings with excellent properties were achieved from a bath composition: 8 g/l PVDF, 0.5 g/l Al₂O₃ and 0.13 g/l iodine dispersed in acetone.

The separator layer was deposited on aluminum substrate and on lithium ion battery electrodes—graphite anode and lithium cobalt oxide cathode.

The optimal deposition regime was carried out by applying a voltage of 100 V DC during 10 minutes. The initial current density depends on the surface area of the substrate, however during the deposition process the current density reduced by a magnitude of order as a result of the creation of an isolating layer. An insulating separate layer, composed of alumina and PVDF, of thickness 10-16 micro meter was achieved.

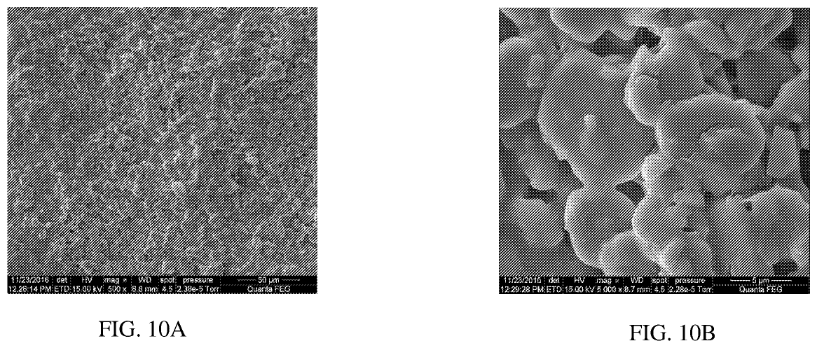

FIGS. 10A-10B show SEM images of a ceramic composite separator deposited according to Example 6 above (relating to electrophoretic deposition).

The resulting separate layer was successfully tested for the following electro-mechanical tests: (1) pencil test (2) tape test (3) electrical isolation test.

It is expected that during the life of a patent maturing from this application many relevant energy storage components, devices, systems, and methods will be developed and the scope of any of the terms electrode, anode, cathode, electrolyte, membrane, energy storage device, and packaging material is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1.-28. (canceled)

29. A packaging element comprising a polymer layer and having a thickness of between 10 and 200 μm;
wherein the packaging element is for use in providing an essentially sealed, void-free enclosure of an energy storage device, and
wherein the polymer is selected from: poly(para-xylylene), poly-mxylylene adipamide, dielectric polymer, silicone-based polymer, polyurethane, acrylic polymer, rigid gas impermeable polymer, fluorinated polymer, epoxy, polyisocyanate, PET, silicone rubber, silicone elastomer, polyamide and any combinations thereof.

30. The packaging element of claim 29, wherein the energy storage device is selected from a capacitor, a supercapacitor, a hybrid capacitor and a battery.

31. The packaging element of claim 29, wherein the energy storage device is a lithium battery or a lithium-ion rechargeable battery.

32. The packaging element of claim 29, wherein the energy storage device comprises one or more of a liquid electrolyte, an ionic liquid, a gel electrolyte or an aqueous electrolyte comprising lithium salt.

33. An energy storage module comprising an assembly comprising two electrode layers and a separator layer disposed therebetween, said energy storage module being enclosed by a packaging element comprising a thin-film polymer layer and having a thickness of between 10 and 200 μm, said packaging element being configured to provide an essentially sealed, void-free enclosure of said energy storage module;
wherein the polymer is selected from: poly(para-xylylene), poly-mxylylene adipamide, dielectric polymer, silicone-based polymer, polyurethane, acrylic polymer, rigid gas impermeable polymer, fluorinated polymer, epoxy, polyisocyanate, PET, silicone rubber, silicone elastomer, polyamide and any combinations thereof.

34. The energy storage module of claim 33, having a volumetric energy density of at least 200 mAh per liter (mAh/l) determined when said module is discharged at a current of 0.01 mA/cm2; or having a gravimetric energy density of at least 40 mAh per g (mAh/g) determined when said energy storage module is charged to nominal voltage and discharged to 50% of the nominal voltage.

35. An energy storage module comprising:
(i) a substrate provided with a plurality of inner surface perforations or with a porous structure having an aspect-ratio above 2;
(ii) an anode;
(iii) a cathode;
(iv) an electrolyte layer disposed between the anode layer and the cathode layer;
wherein said layers being formed on a surface region of said substrate and throughout the inner surface of said perforations, or throughout said porous structure;
wherein said energy storage module being enclosed by a thin-film packaging element having a thickness of between 10 and 200 μm and comprising a polymer, and being configured to provide an essentially sealed, void-free enclosure of said energy storage module;
wherein the polymer is selected from: poly(para-xylylene), poly-mxylylene adipamide, dielectric polymer, silicone-based polymer, polyurethane, acrylic polymer, rigid gas impermeable polymer, fluorinated polymer, epoxy, polyisocyanate, PET, silicone rubber, silicone elastomer, polyamide and any combinations thereof.

36. The energy storage module of claim 35, being an on-chip energy storage device.

37. The energy storage module of claim 36, wherein the on-chip energy storage device is selected from a capacitor, a supercapacitor, a hybrid capacitor and a battery.

38. A plurality of energy storage modules of claim 33, being arranged in a stacked configuration.

39. A method for electrophoretically depositing an electrode film on a substrate, the method comprising:
(i) providing a dispersion comprising a solvent, said dispersion comprising a charger agent and charged particles dispersed therein;
(ii) applying an electrical current sufficient to deposit a film comprising the particles on a surface region of the substrate;
said particles comprise one or more of a functionalized porous carbon, graphite, graphene, carbon nanoparticles, carbon nanotubes, carbon fibers, and carbon rods, nanowires, fullerenes, silicon particles, and lithium titanate (LTO) particles; and said ratio between the charged particles and the charger agent is between 1:10 to 10:1% w/w.

40. The method according to claim 39, wherein the silicone particles are particles of a silicone-carbon composite.

41. The method of claim 39, wherein the ratio between the charged particles and the charger agent is between 1:5 to 5:1% w/w, or between 2:1 to 4:1% w/w or is 3:1% w/w.

42. The method of claim 39, wherein the silicon particles comprises a material selected from silicon oxide particles, silicon nanowires, silicon nanotubes, silicon microparticles and silicon nanoparticles.

43. The method of claim 39, wherein the voltage applied in order to induce an electrical current sufficient to deposit on the substrate an anode film comprising nanoparticles is between 30V to 100V.

44. An electrode film obtainable by the method according to claim 39.

45. The electrode film of claim 44, being essentially free of agglomerates of not more than 50 μm when determined by scanning electron microscopy at a magnification of 5000 and working distance of 11.6 mm.

46. An electrode comprising a substrate and a film, the film comprising particles of a material deposited on a surface region of the substrate;
said particles comprise one or more of a functionalized porous carbon, graphite, graphene, carbon nanoparticles, carbon nanotubes, carbon fibers, and carbon rods, nanowires, fullerenes, silicon particles, lithium titanate (LTO) particles; said electrode being for use in an energy storage device and having 200-2000 mAh/g capacity when cycled vs. lithium ion cathode or lithium metal.

47. The electrode of claim 46, wherein the silicon particles comprises a material selected from silicon oxide particles, silicon nanowires, silicon nanotubes, silicon microparticles and silicon nanoparticles.

48. A method for electrophoretically depositing a composite insulating ceramic material on a substrate, the method comprising:
(i) providing a dispersion comprising a solvent, said dispersion comprising a charger agent and charged particles dispersed therein;
(ii) applying an electrical current sufficient to deposit a film comprising the particles on a surface region of the substrate;
said particles comprise one or more of a polymeric material selected from the group consisting of polyethylene oxide, polyethylene imine, polyethylene imide, polyethylene glycol or any mixture thereof; and a ceramic material selected from the group consisting of alumina, zirconia, silica, cerium oxide particles, YSZ, lithium oxide, graphene oxide or any mixture thereof; and
said ratio between the charged particles and the charger agent is between 10:1 to 100:1% w/w.
